(19) United States
(12) Patent Application Publication
(10) Pub. No.: US 2012/0178065 A1
(43) Pub. Date: Jul. 12, 2012

(54) Advanced Button Application for Individual Self-Activating and Monitored Control System in Weight Loss Program

(76) Inventors: Morteza Naghavi, Houston, TX (US); Albert Andrew Yen, Pearland, TX (US); Haider Ali Hassan, Houston, TX (US); David S. Panthagani, Houston, TX (US); Gregory L. Hennig, Houston, TX (US); Mortaza Mark Naghavi, Katy, TX (US); Susan Michelle Spiering, Richmond, TX (US); Timothy Allen Brinkley, Sugar Land, TX (US)

(21) Appl. No.: 13/346,804

(22) Filed: Jan. 10, 2012

Related U.S. Application Data
(60) Provisional application No. 61/460,904, filed on Jan. 10, 2011.

(51) Int. Cl. G09B 19/00

(52) U.S. Cl. 434/236

(57) ABSTRACT

A mobile programmable device and method providing aural, visual or mechanical stimulus in a program for facilitating weight loss or maintenance. The device may be a mobile phone programmed with a downloadable mobile application. The application program may be modified as a result of user behavior or responses to the application. Thus the application can provide a personalized aid in weight loss control. The application may also provide a link for the user to live coaching assistance, support text messaging or email.

### RELATED APPLICATION

This application claims priority to and incorporates by reference provisional application entitled “Advanced Button Application For Individual Self-activating and Monitored Control System in Weight Loss Program, Ser. No. 61/460,904 filed Jan. 10, 2011.

### FIELD OF THE INVENTION

The present invention disclosed in this specification relates to the field of individual personal body weight loss and body weight control incurred during a weight loss program. The invention provides a contact response “panic button” that an individual may execute at such time of anticipated failure of personal control against the undesired food intake. The invention would provide the individual with a personal response measured according to software pre-programmed levels of response need, varying from an immediate response from the invention itself to GPS contact of additional support performance functions.

### BACKGROUND OF THE INVENTION

Diets and weight loss programs are an imminent part of the population where food may be available in amounts in excess of what an individual should eat to maintain a healthy body. Many individuals attempt personal control or “will-power” to keep their minds off their immediate desire to eat, even when full, out of numerous reasons that may have led to the overweight or out-of-control weight situation. These personal control efforts fail in excessive numbers of attempts.

The weight loss or diet industry is immersed in the cultural population effort to control weight, but these programs have been shown to often result in failure for the individual who then seek successive programs in the hope of control success, but which increasingly results in program-after-program failure for the individual and a final result that the individual gives up the effort and slides into a further unhealthy weight state. Documentation and massive weight-loss program advertising efforts continuously refer to a pattern of continued failure of individual weight control efforts.

### SUMMARY DESCRIPTION OF DISCLOSURE

The disclosure of this application pertains to a portable self-activating monitored support system for individual weight control. The disclosure of the panic-button response gives immediate individual control assistance. Assistance may be programmed and consist of internal activities as well as from outside resources when determined appropriate. The internal activity may be an immediate negative result picture suggestion to help the person of a mental or psychological avoidance stimulator or it may initiate a phone contact to reach a program system personal contact for phone support from another person. The system personnel may be another program participant with whom the “panic-button” initiator is familiar and can work with to get past the immediate temptation or an individual of the weight-loss-control program trained to help the person in need get past the immediate personal crisis.

The device may utilize software. The system software is platform independent—that is, it could be installed and executed on any mobile or desktop computer platform or operating system. This software can be modified by the user history in interfacing with the software.

The device also may react according to the level of need indicated by the person activating the button and vary the level of response accordingly.

The device, which remains dormant except when activated, may maintain or keep a record of the user's action in activating the functions described in this disclosure, providing a further support record available for use in future evaluation of determination of what works for an individual and what does not work. This data may be accessible to the individual user (hereinafter “user”) and to the program system for further aid or maintenance.

While the disclosure maintains both a record of its actions and the activity response actions of the individual, along with GPS capability for expanded use, the product of the disclosure does not broadcast results or analysis publicly and remains and retains individual privacy control of level sufficient to meet required governmental standards for individual privacy. The system disclosure may include a spam filter.

The disclosure provides an alternative to weight loss programs that require the maintenance of physical results record-keeping, although private record-keeping may be provided when desired. It also provides an alternative to individual reliance on unassisted programs. The disclosure provides various modes of assistance that can be provided at the election of the user.

The device described in this disclosure is designed to provide positive and negative feedback actions, depending on varying input directives, designed to be a part of a system engaged and individual self-motivational method for positive results planning.

A feature of the device is to allow the individual user to record his/her voice onto the software program for later use, such as when the client is simply looking for or needs a word of motivation and will hear his or her own voice reciting pre-programmed goals or aspirations.

The device button can be programmed, as needed and individually planned, to give healthy tips, pictures, or motivational sayings when the device button is pressed. In one embodiment, the user can program the device to contact a specified individual for assistance.

Just as positive motivational reply may be used, the device may also be individually programmed for negative result pictures, suggestions of negative results realized from the adverse action or other similar pop-up visual motivation from the negative impulse reaction as well as the positive reinforcement response.

The application, including software, can be modified in operation based upon the user's past requirements. For example, a user that has utilized live coaching may be directed to this option. This may be to the exclusion of options for user recorded motivational statements.

### SUMMARY DESCRIPTION OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates a side perspective view of glasses or eyewear that may be worn by the user. Such an eyewear may contain neurologic, mechanical, movement, or electrical sensors to measure neurologic, muscular, or eating activity.

### DETAILED DESCRIPTION OF THE INVENTION

The disclosure describes a method and device for facilitating weight loss control. The disclosure comprises a method and a system that utilizes a hand held mobile device such as a smart phone or tablet computer. The mobile device utilizes wireless or mobile phone communication networks including but not limited to the Internet or email. The device can include privacy protection components such as spam filters. The method and apparatus of the disclosure may utilize a browser connecting the device to the web and a software application (hereinafter “App”) designed to operate on the mobile device and that incorporates the features of the disclosure. The disclosure describes a system comprising of hardware, software, or a combination thereof, that can perform the following features:

Wearable or Implantable Device

The system may consist of a wearable or implantable device where:

i. The device may be worn around the neck, wrist, head, ear, or legs.

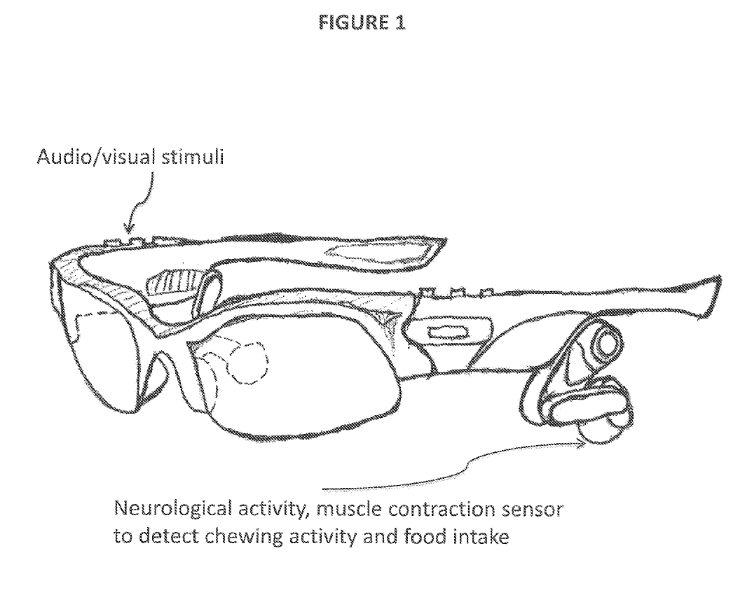

ii. One embodiment of the wearable device may be an electronic eye-wear device. In this embodiment, the eyewear detects the jaw motion to monitor eating habits in conjunction with activity monitoring. The device also counts the number of time the food is chewed. See FIG. 1, including neurological activity, muscle contraction sensor to detect chewing activity and food intake. See also audio/visual stimuli components located in the temple of the eyewear frame.

iii. One embodiment of the wearable device may be an electronic neck wear.

This device measures the jaw and neck motion to determine if the client is eating food, how many times the food is chewed, and how many times the food is swallowed. This device could also measure neurological activity and muscle contractions as means of detecting food intake. In one embodiment, such measurements can be made by monitoring electrical activities that arise due to eating. The data from the wearable device will allow the system software, coach or another monitor to make assessments of the user's mood, as well as location and level and nature of physical activity.

Meal Guidance

The meal guidance system may run in real-time while the user eats and can be programmed with question and answer criteria that scores the user based on their meal time actions, in conjunction with data from the accompanying sensors.

i. Bite pace is met—user is coached to consume a meal at a certain pace

ii. Calorie intake is met—user is budgeted with a daily calorie budget and the system monitors and discourages excess calorie intake and compares against this reference;

iii. Number of times each food bite is chewed;

iv. Overall meal time is met—user is coached to consume a meal within a certain amount of time optimal to reach goal;

v. Questionnaires, in conjunction with biometric data, is used to gauge the user's mood and level of satisfaction with the meal;

vi. The system gives the user a rating for the meal after finishing to gauge adherence to the prescribed methods by the coach—these ratings can be trended, monitored, and reported;

vii. The system suggests pre and post meal activities such as a certain calorie snack prior to the meal and a specified duration walk after the meal.

The system features a guidance or movement monitoring system to be run during meals that coaches the user on food intake timing, pace, and calorie budget.

Panic Button

The system contains a panic button to allow the user to get help in case of an emergency where emergency is defined as an imminent deviation from the prescribed coaching routine, such as a weight loss program. The help could be in terms of:

i. Automated help from local device—in terms of images, audio clips, video clips, questionnaires, user recorded motivational messages or other information.

ii. Remote help in form of digital communication such as SMS/MMS text messages or email messages.

iii. Remote automated help that is obtained from a server with data and algorithms, over a communication network. The automated help could be a real-time computer generated intelligent voice that responds to the client's inputs. It could be real-time visual or text based response as well.

iv. Remote help in terms of audio, visual communication with a coach, i.e., an individual involved in the direction, instruction and training of the user, or therapist.

The panic button can be an icon displayed on the screen of the tablet computer or smart phone or an actual key located on a physical keyboard. Touching or pressing the icon or key will trigger various responses of the application software.

In one embodiment, the system automatically detects that the user is going to fail at meeting the meal's prescribed obligations (e.g. calorie budget, bite pace, satisfaction, etc.) or prescribed coaching routine (behavior prescribed by the coach with the user). In one embodiment, the system may automatically trigger the panic button, i.e., trigger responses in the application software.

i. The system may report the transgression behavior to the coach to ensure compliance.

ii. The system may encourage user to press the panic button to seek help.

The system automatically detects the user's physical and emotional state based on the biometric data such as blood pressure, heart rate, EKG, etc. In one embodiment, the system may trigger the panic button based on a biometric threshold. As discussed, triggering of the panic button triggers a software application response. Such a response may be to summon a coach, i.e., place a coach into communication with the user by calling the smart phone device or text messaging the tablet computer.

The panic button is only enabled after some chain of events has occurred (calorie budget exceeded, mood is depressed for predetermined amount of time, etc.). The chain of events is based on guided coaching and can be programmed by the coach real-time or during the setup encounter with the user. The re-programming can also be accomplished by the system algorithms.

Once the panic button is initiated, the user may be presented with a questionnaire to determine the best course of action based on a suggestion table, flow chart, or decision tree. The system may automatically skip this questionnaire based on the user's history, i.e., past use of a coach, nutritionist, etc.

i. Decision tree can be cloud based, data mining of PHR (Personal Health Record), EHR (Electronic Health Record), and recognized medical data bases using established business intelligence algorithms (Google, IBM, etc.)

ii. First question can be “in case of real medical emergency, please call 911 for emergency response”

The panic button can initiate human contact with the coach, nutritionist, fitness trainer, psychologist, etc. through any of the following:

i. Video chat, conference

ii. Voice call

iii. Text message

iv. Email Once the panic button is activated, an email may be sent to a distribution list of coaches containing all user history (meal, calorie intake, weight, medical conditions, monthly statistics or statistical summaries, etc.) so any coach may immediately respond or elevate the panic button call to the proper person.

Automated or Controlled Food Dispenser

One embodiment of the meal guidance and control system consists of an automated or remotely controlled food dispenser that releases the food to the client with the prescribed amount and time delay thus allowing manipulation of the client's eating habits and behavior. The client may be a child.

In one embodiment, the box dispenses food and beverages with an acceptance of a token. For example, in this version a parent, or a coach, may issue a certain amount of tokens to the client or a child where the client or the child can get their food at any time of the day but the number of times will be restricted by the number of tokens. This will allow the client's behavior to be controlled. The automated box may be used to control other substances such as cigarettes, alcohol, or other substance use of which is desired to be curbed.

In one embodiment, the automated or controlled food dispenser does not dispense food, or calories containing products, in close intervals of time. The client has to wait certain duration of time to receive the food.

In one embodiment, the automated box acts as a health and wellness management machine. Based on the client's specific age and health status, the box dispenses supplements, and medication, to maintain or improve the health status of the individual. The box also performs basic, at-home, blood and urine analysis to monitor the health status of the client. The box shares the health status of the client and the compliance or usage data of the device to an online repository such as a PHR (personal health records) portal.

Communication and Coaching

The system implements and distinguishes between two types of alerts:
i. Panic Alerts: these alerts are triggered when the client feels the urge to indulge in behavior that is desired to be curbed, such as food intake, alcohol consumption, cigarette smoking, or other psychological or physical activities. These alerts can be triggered by the client or automatically by the system based on a decision tree of conditions.
ii. Coaching/Monitoring Alerts: these alerts are triggered in response to non-urgent situations such as daily progress of monitored parameters. For example, for weight loss, a coaching trigger may be triggered if the client has reached their caloric budget for the day or has not logged in their exercise.
The system is able to determine the stress level of the user and monitors, saves, and reports this data to enable the user and the coach to practice stress reduction in the user's life.

The system is able to perform behavioral, psychological, and physical intervention to help the client with the compliance to the prescribed routine.
The system is able to deliver inhibitory stimuli such as auditory alerts, visual stimuli, and biometric stimuli such as a mild electric shock, vibrations, or buzzing.
The system can use GPS location to log position data and perform speed, mileage, and other similar measurements for outdoor activities. This information may be presented in real-time or offline on a map or text information.
The coach can remotely monitor the GPS and activity monitoring systems and provide help and guidance to improve exercise outcomes, such as running, by providing motivation during the course of the activity, and a virtual activity peer.
The system can detect relative position in the house or other place of interest, such as work office, of food storage. The system may alert the user to curb unsubscribed visits to the place of food if the user is deviating from the recommended behavior. The automated monitor in the system could be monitoring this information in real-time.

i. The system may communicate with wireless tags to determine locations of interest or items of interest such as food and beverage containers.

ii. The system may use GPS information or other triangulation techniques to determine the locations of interest, such as the location of a refrigerator.
The system can vibrate or make a noise to remind and/or notify the user and coach regarding real-time or pre-programmed event triggers or alerts. For example, if the user is in a specific location for too long, or too often (in a restaurant, kitchen, sitting at desk, sitting on couch, etc).

The system has the ability to:
i. Monitoring the user via the device camera and guiding the user through the meal with audio/visual cues.
ii. By detecting vibrations from the surface where the meal is taken, when laid flat on the surface. This information may be used to guide the user through the pacing and timing of the meal.
The system has the ability to track compliance through use of statistics. The system may present compliance and tracking information in a form of charts.
The system has the ability to utilize social networking as a tool to help the user by sharing information between individuals or groups with similar goals. Health and biometric parameter monitoring
In one embodiment, the system is able to monitor, track, and report sleeping patterns and activity during sleep.
The system possesses means of communicating with external modules to collect biometric, location, environment, audio, visual, and position data to monitor the user's behavior. This data may be used to alter behavior modification goals in real-time, i.e., concurrent with the monitoring activity, or offline for later use and review, including software modification. The data may be utilized by a remotely located coach who may be in communication with the user. The data may also be utilized locally on the device, such as in an automated decision tree utilized by the user. As used herein, a coach is an individual involved in the direction, instruction and training of a user. The device may collect the following data, but not limited to:

iii. Electro-cardiogram (ECG)

iv. Blood pressure

v. Temperature

vi. Heart rate

vii. Movement, activity monitors

viii. Galvanic skin response (skin conductance response)

ix. Altitude/elevation

x. User image (pictures, video, augmented reality)

xi. GPS and local space positioning (to monitor movements like picking up a fork, etc).

General
The system may be installed in mobile phones independently or can be self-contained device with its own hardware that is carried with the user at all times (belt clip, in pocket, worn as a jewelry, wrist/arm band, etc.)
The system can use the GPS location data to suggest recommended places to the user such as restaurants, gymnasiums, relaxation spas, etc.
The system is able to communicate with existing commercially available devices (invasive and non-invasive) such as medical devices and activity monitors, such as FitBit, JawBone UP, and BodyBug.
The disclosure also comprises methods for facilitating behavioral modification, e.g., weight loss control, utilizing mobile devices and connection to networks such as the Internet or email.
The application software of the system is platform independent—that is, it could be installed and executed on any mobile platform or operating system. In one embodiment, the disclosure may be also operated on a desk top computer system. In one embodiment, the App can be operated on Safari, Internet Explorer, Firefox, Google Chrome and Opera.
This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.
While specific embodiments have been illustrated and described, numerous modifications are possible without departing from the spirit of the invention, and the scope of protection is only limited by the scope of the accompanying claims.

What is claimed is:

1. A personalized behavioral management system, comprising of hardware and software that can enable a coach and coachee to communicate for the purpose of behavior control or modification, which includes the following features and components:
a) A mobile, personal digital assistance device (PDA), with wireless communication;
b) A wearable or implantable device that obtains activity or biometric data and location data from the coachee and stores the data locally and remotely;
c) A help button that initiates a series of previously programmed commands stored locally on the PDA device or remotely on a server, to prevent the coachee from deviating from or failing to follow the prescribed behavioral modification program;
d) A panic button that initiates direct contact with the coach or with a response center;
e) Ability to automatically detect when the coachee is deviating from the prescribed behavioral modification program and automatically notify the coach or a response center.

2. The system of claim 1 wherein the behavior is eating habit and the purpose is to control weight and induce weight loss.

3. The system of claim 2 wherein the pre-programmed commands include a series of appetite suppressing stimuli.

4. The system of claim 2 wherein the biometric data obtained from the coachee can be used to calculate caloric expenditure of the coachee.

5. The system of claim 1 wherein the behavior is substance abuse, addiction or mood disorders.

6. The system of claim 1 where the pre-programmed commands include inhibitory stimuli to the coachee, such as auditory alerts, visual stimuli, and biometric stimuli such as a mild electric shock, vibrations, or buzzing.

7. A system for personalized coaching of eating behavior that can enable a coachee to receive coaching instructions during a meal, which includes the following features and components:
a) A timer;
b) A bite counter;
c) A chewing counter;
d) Audio, visual, or audio-visual interface;
e) A coaching protocol.

8. The system of claim 7 wherein the purpose of the system is weight control or weight loss.

9. The system of claim 7 wherein the coach is an automated system such as a voice activated interactive program, or an App on a mobile device.

10. The system of claim 7 wherein the coach is a person and the communication is real-time (live).

11. The system of claim 7 wherein the bite counter is an automated device.

12. The system of claim 7 wherein the bite counter is a PDA or mobile App utilizing a camera and motion detection.

13. The system of claim 7 integrated into a TV, a home appliance, a dining table, or as part of a smart home system.

14. A personalized food dispensing system controlled by a coach or a caretaker for the purpose of controlling eating behavior, with the following features:
a. Automatically dispenses a certain amount of food, at certain times, with programmed time intervals;
b. Can be controlled remotely by the coach or caretaker to dispense food;
c. Dispenses food based on physical tokens or electronic coupons but does not allow food dispensation outside of the programmed time interval.

15. The system of claim 14 wherein the electronic coupon is generated by an activity monitor.

16. The system of claim 14 wherein the food dispenser is capable of receiving data from an activity monitor and then dispensing food based on the program and the caloric expenditure data from the activity monitor.

17. The system of claim 14 also functioning as a refrigerator.
